(19) United States
(12) Patent Application Publication
(10) Pub. No.: US 2008/0183567 A1
(43) Pub. Date: Jul. 31, 2008

(54) Method and System for Updating Links

(76) Inventor: Kayhan Utkutug, Stockholm (SE)

Correspondence Address: HARNESS, DICKEY & PIERCE, P.L.C., P.O. BOX 8910, RESTON, VA, 20195, US

(21) Appl. No.: 11/667,021

(22) PCT Filed: Nov. 8, 2005
(86) PCT No.: PCT/SE05/01672

§ 371 Date: Oct. 15, 2007

(30) Foreign Application Priority Data
Nov. 8, 2004 (SE) 0402771-0

(51) Int. Cl. G06F 15/16; G06Q 30/00

(52) U.S. Cl. 705/14; 709/203

(57) ABSTRACT

An embodiment of the present invention relates to the updating of links on a first web site based on measurements on destination web sites. First links for directing users from a first web site to other web sites are provided and the directing of first users from the first web site to one or more other web sites via one or more of the first links is determined. Actions of the first users with respect to the one or more other web sites are measured and the first links are updated in response to the received measurements. Then the updated links are provided for directing subsequent users from the first web site to other web sites.

### FIELD OF THE INVENTION

The invention generally relates to web sites on the Internet, and more specifically to providing links for directing users from a web site to other web sites.

### BACKGROUND OF THE INVENTION

The amount of web sites that can be reached via the Internet, and the amount information on these web sites, is immense. In view of this, there is problem for users of the world wide web to find and visit web sites comprising information of their interest.

In order to alleviate this problem, several different means have been provided to find web sites having a content of interest.

For example, search engines generally catalogue web sites and links thereto for later retrieval in view of a set of search terms.

Also, web sites having a content related to a specific area of interest, generally include links to other sites having contents related to the same or a similar area of interest.

U.S. Pat. No. 6,014,638 discloses a system for customizing content of a electronic shopping service site to which an individual user can connect. The content to be customized may for example be in the form of links to merchant sites preferred by the individual user. The preferences of the individual user is identified in view of personal information provided to the electronic shopping service and of and earlier behaviour of the individual user. This type of system is suitable in a situation where an individual user connects to the same shopping service site on several occasions, and has registered with, or at least provided personal information to, the shopping service site in advance.

A problem with the prior art systems which remains, is to enhance the provision on a web site of links to other web sites of interest, also for a new user of the web site without having access to individual information regarding this new user.

### SUMMARY OF THE INVENTION

An object of the invention is to provide an improved method, and a corresponding system and computer readable medium comprising a computer program product, for providing links between web sites, that at least alleviates the problems of prior art.

The invention makes use of the recognition that users visiting a first web site, show an interest in the same content, namely the content of the first web site. In view of this interest in the same content, the users visiting the first web site, or at least a subset of the users, are likely to share other common interests and to have similar preferences.

According to an aspect of the invention a method of providing links between web sites, is provided. First links for directing users from a first web site to other web sites are provided. Furthermore, it is determined that first users have been directed from the first web site to one or more other web sites by means of one or more of the first links. Measurements of actions of the first users with respect to the one or more other web sites are received, and the first links are updated in response to the received measurements. The updated links are then provided for directing subsequent users from the first web site to other web sites.

The term “link” is to be interpreted as both the URL (Uniform Resource Locator) and the format in which it is provided on a web page. Hence, updating of links may refer both to change of URLs and to change of format of provision on web pages.

Instead of manually guessing common preferences of users of a web site, in the method of the invention, measurements of the actions of the users on other web sites are used to identify common preferences. The method of the invention facilitates the use of automated updating of links from a first web site to other web sites in view of actions of the users of the first web site in respect to the other web sites to which the users have been directed from the first web site. These updated links may then be used for directing subsequent users from the first web site to other web sites without having any prior knowledge of the preferences of the subsequent users other than that they visit the first web site.

In an embodiment of the invention, the measurements indicate whether or not the first users being directed to the one or more other web sites perform preferred actions on these one or more other web sites. Preferred actions may in this embodiment be actions that the provider of the first web site prefers the users to perform. The actions may then be categorised and given a measure which indicates which actions are more preferred than other in the eyes of the provider of the first web site, e.g. by means of a preference level. Having received such measurements, links of the first links which to a higher degree, e.g. more times per time unit, have lead to preferred actions on the web sites to which they direct users, should be provided to a higher degree in the updated links. By using the updated links, subsequent users are more likely to perform the preferred actions on the web sites to which they direct users.

In a preferred embodiment of the invention the first links are provided in an advertisement. In this embodiment the received measurements may e.g. indicate a value of purchases during a period of time by the first users with respect to each of the one or more other web sites to which they have been directed by means of the first links. Preferred links of the first links are then identified as the links that direct users to the web sites for which measurements have been received indicating the highest a value of purchases during a period of time. Preferred links are then prioritised amongst the updated links. Links not belonging to the preferred links are not prioritised and may even be removed from the first links to produce updated links. Each link of the first links is preferably provided for exposure to a certain portion of users of the first web site. The first links are updated by providing each preferred links for exposure to a larger portion of the users of the first web site than links which are not preferred links.

According to other aspects of the invention a system having means for performing the steps of the method of the invention and a computer readable medium having computer-executable instructions for causing a general purpose computer to perform the steps of the method of the invention are provided.

### BRIEF DESCRIPTION OF THE DRAWINGS

In the following, embodiments of the invention are illustrated by way of example and not limitation with reference to the accompanying drawings, in which:

FIG. 1 shows a schematic view of a system in which embodiments of the invention may be implemented; and

FIG. 2 shows a schematic flow chart of an embodiment of a method according to the invention.

### DETAILED DESCRIPTION OF EMBODIMENTS

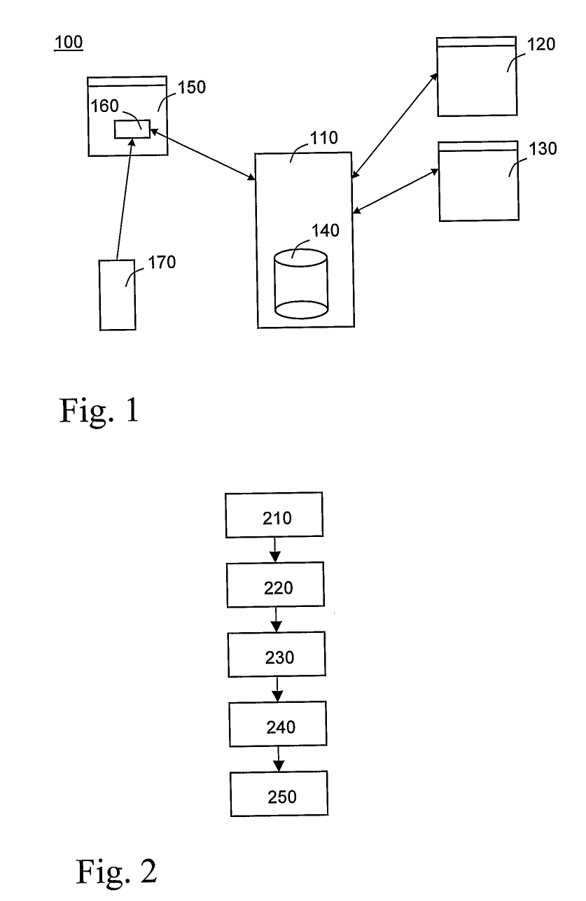

In FIG. 1 a schematic view is shown of a system 100 in which embodiments of the invention may be implemented. A third party system 110 for providing coordination of online advertisement is interfaced with e-commerce web sites 120, 130 of a number of advertisers. Each advertiser has a product database including the products which are on sale through a respective e-commerce web site 120, 130. Copies of the product databases are transferred from the e-commerce sites 120, 130 of the advertisers to the third party system 110 regularly and stored in a database 140 in the third party system 110. Whenever changes have been made to the product databases of the advertisers, such changes are transferred to the database 140 of the third party system 110. The information in the product databases may vary a lot between different advertisers, but generally include pictures, descriptions and prices of the products of the advertisers.

The choice of two e-commerce sites 120, 130 of FIG. 1 is for pure illustrative purposes. An arbitrary number of e-commerce sites may be interfaced with the third party system 110.

Further, in the system 100 of FIG. 1, an affiliate web site 150 is interfaced with the third party system 110. More, specifically the affiliate site 150 provides space in one or more web pages of the site 150 for showing advertisements 160 of products of the advertisers for presentation to a user 170 visiting the affiliate web site 150. Each advertisement may include images, prices, descriptions etc. of one or more products of one or more advertiser, as included in the transferred copies of the product databases. Furthermore, the advertisement comprises links to the e-commerce sites offering the products. Each product of an advertisement preferably corresponds to a link to a web page providing more information of the respective product, and/or the option to purchase the product. The web page preferably also provide options to view and/or purchase other products of the respective advertiser.

As the space of a web page is limited, the affiliate web site 150 generally selects to rotate a number of advertisements 160 so that each advertisement is exposed only a percentage of the times the web page is presented to a new visitor. For example, each advertisement may be shown equally often, by showing a new advertisement for each new visitor of the web page until all advertisements have been shown and then starting from the first advertisement again.

The advertisements 160 of the affiliate web site 150 is preferably provided by means of an iframe or a JavaScript. When the user 170 visiting the affiliate web site 150 is presented with the advertisements 160 and clicks on a link corresponding to a product presented in the advertisements 160, this will be recorded by the third party system 110, preferably by placing a cookie in the web browser of the user 170 identifying the transaction by means of a unique identification, the e-commerce site, the affiliate web site 150, the advertisement 160, and the link by means of which the user 170 was directed to the e-commerce site of the advertiser.

The cookie then responds to scripts placed in the e-commerce site of the advertiser. These scripts then report measurements of the actions of the user 170 with respect to the e-commerce site 120, 130 of the advertiser, such as purchase of a product, to the third party system 110.

The third party system 110 then uses the measurements to update the advertisements 160 of the affiliate site 150. For example, measurements indicating desired user actions on a web site would lead to the updating of the advertisement 160 so that the link to that web site is exposed to a larger portion of the users. Similarly measurements not indicating desired user actions on a web site would lead to the updating of the advertisement 160 so that the link to that web site is exposed to a smaller portion of the users.

FIG. 2 shows a schematic flow chart of an embodiment of a method according to the invention. The method may advantageously be implemented in a system as shown in FIG. 1.

In a first step 210, first links of the links provided in the third party system are provided in advertisements 160 of an affiliate web site 150. The links are provided by means of the third party system 110 in advertisements 160 which are rotated on the affiliate web site 150 so that each advertisement, and hence each link, is exposed only a percentage of the times the web page is presented to a new visitor. Each advertisement may include one or more links. Each link of the first links are to a respective web page of the advertiser sites 120, 130, the respective web page providing more information of a product, and/or the option to purchase the product.

In a second step 220, it is determined by means of the third party system 110, that first users 170 have been directed from the affiliate web site 150 to one or more of the advertiser web sites 120, 130 by means of one or more of the links in the advertisements 160. The determination is done by placing a cookie in the web browser of each of the first users identifying the user and the advertisement 160 by means of which the user 170 was directed to the e-commerce site of the advertiser.

In a third step 230 measurements of the actions of the first users with respect to one or more of the advertiser web sites 120, 130. The cookie placed in each of the users 170 web browser then responds to scripts placed in the e-commerce sites 120, 130 of the advertisers. These scripts then report measurements of the actions of the user 170 with respect to the e-commerce site 120,130 of the advertiser, to the third party system 110. The measurements received by the third party system 110 in this embodiment is the value of the purchases of each user 170 when visiting a e-commerce site after being directed to the e-commerce site by means of a link of the first links of the advertisements 160.

From these measurements the third party system 110 can calculate the value of purchases during a period of time with respect to each link of the first links.

In a fourth step 240, the first links are then updated after a predetermined period of time in view of the received measurements. In this embodiment the links which have the larges value of purchases during the predetermined period of time are identified as preferred links. The advertisement 160 is then updated to produce updated links where each preferred link of the first links are exposed to a larger portion of the users, and each link of the first links that does not belong to the preferred links is exposed to a smaller portion of the users or is not exposed at all.

The updated links are then provided in the advertisements 160 of the affiliate web site 150 in step 250.

In alternative to updating the advertisement 160 with respect to exposure of links of the first links, the advertisement can also be updated with respect to the format in which the links are exposed to visitors of the affiliate web site 150. For example, links not belonging to the preferred links can be updated so that they are exposed in the same or a similar format as preferred links.

Furthermore, the advertisement 160 can be updated by adding links to web sites having similar contents as web sites for which preferred measurements have been received.

1. A method of providing links between web sites, comprising the steps of:
providing first links for directing users from a first web site to other web sites;
determining that first users have been directed from the first web site to one or more other web sites by means of one or more of the first links;
receiving measurements of actions of the first users with respect to the one or more other web sites;
updating the first links in response to the received measurements; and
providing the updated links for directing subsequent users from the first web site to other web sites.

2. The method of claim 1, wherein the step of updating comprises:
updating the first links so that links of the first links are exposed to a portion of the users of the first web site in response to the received measurements to produce updated links.

3. The method of claim 1, wherein the step of receiving comprises:
receiving measurements indicating a preference level of the actions of the first users with respect to the one or more other web sites, and the step of updating comprises:
updating the first links in response to the received preference levels.

4. The method of claim 3, wherein the step of updating comprises:
identifying preferred links of the first links in view of the preference levels indicated by the received measurements; and
updating the first links so that links of the first links not being preferred links are exposed to a smaller portion of the users of the first web site, and preferred links are exposed to a larger portion of the users of the first web site.

5. The method of claim 3, wherein the first links are provided in an advertisement and the preference levels indicate the amount of money spent per time unit by the first users with respect to the one or more other web sites.

6. The method of claim 1, wherein the first links are provided in an advertisement, the step of receiving comprises:
receiving measurements indicating amount of money spent per time unit by the first users with respect to each of the one or more other web sites,
and the step of updating comprises the steps of:
identifying preferred links of the first links as the links of the first links directing users to the web sites of the one or more other web sites for which measurements indicating the highest amount of money spent per time unit have been received; and
updating the first links so that links of the first links not belonging to the preferred links are exposed to a smaller portion of the users of the first web site, and preferred links are exposed to a larger portion of the users of the first web site.

7. The method of claim 1, wherein the step of updating further comprises the step of:
adding links to the first links to produce updated links.

8. The method of claim 7, wherein the step of updating further comprises the step of:
adding links to web sites having similar contents as web sites for which preferred measurements have been received.

9. The method of claim 1, wherein the links of the first links have different presentation formats, and the step of updating comprises:
updating the presentation format of the first links in response to the received measurements to produce updated links.

10. The method of claim 1, wherein the links of the first links have different presentation formats, the step of receiving comprises:
receiving measurements indicating a preference level of the actions of the first users with respect to the one or more other web sites,
and the step of updating comprises:
identifying preferred links of the first links in view of the preference levels indicated by the received measurements; and
updating the format of links of the first links not being preferred links to the presentation format of the preferred links to produce updated links.

11. A system for providing links between web sites, comprising means for performing steps of the method of claim 1.

12. A computer readable medium having computer-executable instructions for causing a general purpose computer to perform the steps of the method of claim 1.

13. The method of claim 4, wherein the first links are provided in an advertisement and the preference levels indicate the amount of money spent per time unit by the first users with respect to the one or more other web sites.

14. The method of claim 2, wherein the step of updating further comprises the step of:
adding links to the first links to produce updated links.

15. The method of claim 14, wherein the step of updating further comprises the step of:
adding links to web sites having similar contents as web sites for which preferred measurements have been received.

16. A system for providing links between web sites, comprising means for performing steps of claim 2.

17. A computer readable medium having computer-executable instructions for causing a general purpose computer to perform the steps of claim 2.
